(19) United States
(12) Patent Application Publication
(10) Pub. No.: US 2013/0133004 A1
(43) Pub. Date: May 23, 2013

(54) METHOD FOR PERFORMING BROADCASTING PROGRAM SCHEDULE CONTROL THROUGH ELECTRONIC DEVICE, AND ASSOCIATED APPARATUSES

(71) Applicant: Jinlong Li, Hefei City (CN)

(72) Inventor: Jinlong Li, Hefei City (CN)

(21) Appl. No.: 13/382,515

(22) PCT Filed: Nov. 17, 2011
(86) PCT No.: PCT/CN2011/082335

§ 371 Date: Jan. 5, 2012

(51) Int. Cl. H04N 21/482

(52) U.S. Cl. 725/43

(57) ABSTRACT

A method for performing broadcasting program schedule control through an electronic device includes: obtaining EPG data from outside the electronic device, for use of broadcasting program schedule control, wherein the EPG data includes broadcasting schedule information of a plurality of multichannel broadcasting programs; and parsing the EPG data, and further providing a user with at least one hint through the electronic device, allowing the user to designate at least one multichannel broadcasting program to be viewed within the plurality of multichannel broadcasting programs. Associated apparatuses for performing broadcasting program schedule control are also provided. For example, an apparatus can be at least one portion of an electronic device, and more particularly, includes a data retrieving module and a schedule control module. In another example, another apparatus can be at least one portion of a multimedia player, and more particularly, includes a BPCP serving module and a service control module.

### TECHNICAL FIELD

The present invention relates to broadcasting program schedule control, and more particularly, to a method for performing broadcasting program schedule control through an electronic device, and to associated apparatuses.

### BACKGROUND

Typically, a television (TV) such as a liquid crystal display (LCD) TV designed to display high definition images is heavy for a user, and therefore, nobody will bring the aforementioned LCD TV with himself/herself for a purpose of viewing TV programs. The user may use some cables to connect a digital video recorder (DVR), a digital versatile disc (DVD) player, a set top box (STB), etc. with the TV, in order to set up a home theater system in a living room, where the DVR may be utilized for recording a video program. In a situation where the DVR can receive TV signals by itself and is equipped with an auto-timer function for automatically recording a TV program at a predetermined time, the user may view the TV program automatically recorded by the DVR when needed. When the user is travelling around the country, some problems may occur. For example, the user cannot use the whole home theater system at once. In another example, it seems unlikely that the user will have enough time to view a lot of TV programs automatically recorded by the DVR after he/she goes home. Thus, a novel method is required in order to provide the user with better viewing experience of multichannel broadcasting programs.

### SUMMARY

It is therefore an objective of the claimed invention to provide a method for performing broadcasting program schedule control through an electronic device, and to provide associated apparatuses, in order to solve the above-mentioned problems.

An exemplary embodiment of a method for performing broadcasting program schedule control through an electronic device comprises: obtaining electronic program guide (EPG) data from outside the electronic device, for use of broadcasting program schedule control, wherein the EPG data comprises broadcasting schedule information of a plurality of multichannel broadcasting programs; and parsing the EPG data, and further providing a user with at least one hint through the electronic device, allowing the user to designate at least one multichannel broadcasting program to be viewed within the plurality of multichannel broadcasting programs.

An exemplary embodiment of an associated apparatus for performing broadcasting program schedule control is provided, where the apparatus comprises at least one portion of an electronic device. The apparatus comprises a processing circuit arranged to perform broadcasting program schedule control, wherein the processing circuit comprises a data retrieving module and a schedule control module. The data retrieving module is arranged to obtain EPG data from outside the electronic device, for use of broadcasting program schedule control, wherein the EPG data comprises broadcasting schedule information of a plurality of multichannel broadcasting programs. In addition, the schedule control module is arranged to parse the EPG data, and further provide a user with at least one hint through the electronic device, allowing the user to designate at least one multichannel broadcasting program to be viewed within the plurality of multichannel broadcasting programs.

An exemplary embodiment of an associated apparatus for performing broadcasting program schedule control is provided, where the apparatus comprises at least one portion of a multimedia player. The apparatus comprises a processing circuit arranged to perform broadcasting program schedule control, wherein the processing circuit comprises a broadcasting program control protocol (BPCP) serving module and a service control module. The BPCP serving module is arranged to receive at least one notification/command from outside the multimedia player through a BPCP, wherein the at least one notification/command carries information corresponding to a multichannel broadcasting program to be viewed. In addition, the service control module is arranged to control operations of the multimedia player in response to the at least one notification/command, in order to provide a user with a service corresponding to the multichannel broadcasting program.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1A is a diagram of an apparatus for performing broadcasting program schedule control according to a first embodiment of the present invention.

FIGS. 1B-1C respectively illustrate some implementation details involved with the apparatus shown in FIG. 1A according to different embodiments of the present invention.

FIG. 1D is a diagram of an apparatus for performing broadcasting program schedule control according to another embodiment of the present invention.

FIG. 2 is a flowchart of a method for performing broadcasting program schedule control through an electronic device according to an embodiment of the present invention.

FIGS. 3A-3C illustrate some implementation details of the method shown in FIG. 2 according to different embodiments of the present invention.

FIGS. 4A-4B illustrate some implementation details of the method shown in FIG. 2 according to different embodiments of the present invention.

FIGS. 5A-5C illustrate some implementation details of the method shown in FIG. 2 according to different embodiments of the present invention.

FIG. 6A is a diagram of an apparatus for performing broadcasting program schedule control according to a second embodiment of the present invention.

FIG. 6B is a diagram of an apparatus for performing broadcasting program schedule control according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

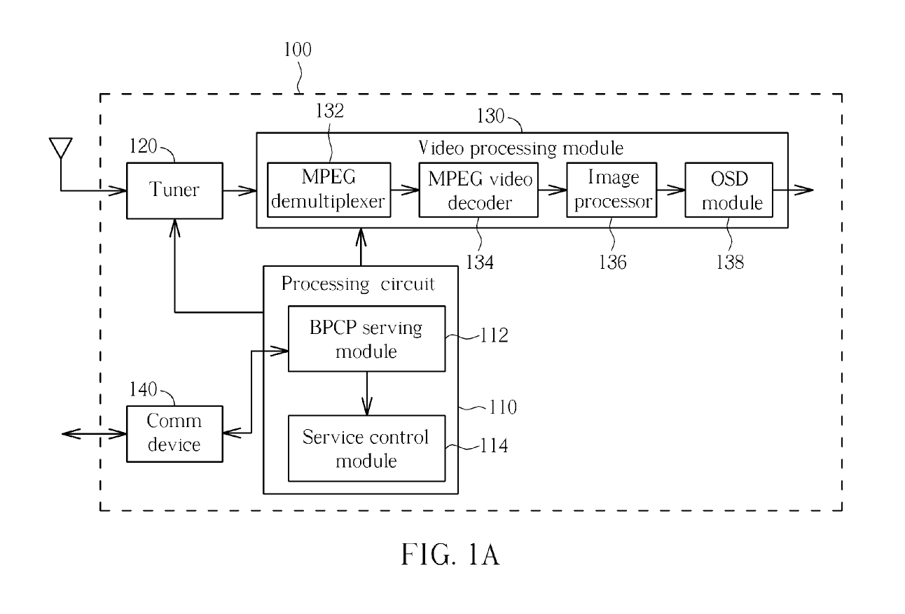

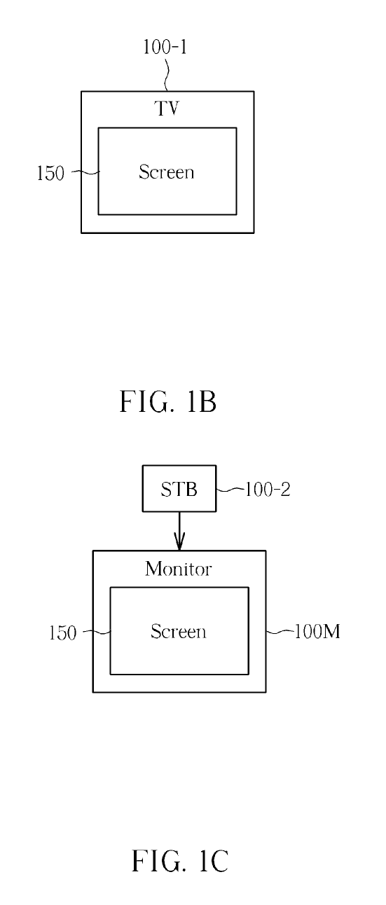

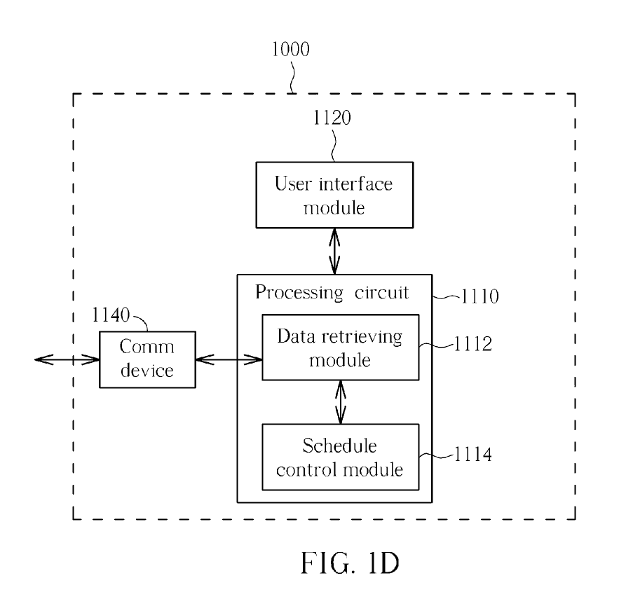

Please refer to FIG. 1A, which illustrates a diagram of an apparatus 100 for performing broadcasting program schedule control according to a first embodiment of the present invention. For example, the apparatus 100 can be utilized for viewing one or more multichannel broadcasting programs. The apparatus 100 comprises a processing circuit 110 arranged to control operations of a multimedia player, where the processing circuit 110 comprises a broadcasting program control protocol (BPCP) serving module 112 and a service control module 114. In particular, the apparatus 100 of this embodiment may further comprise a tuner 120, a video processing module 130, and at least one communication device 140 (labeled “Comm device” in FIG. 1A), while the communication device 140 can be utilized for performing communication operations, and more particularly, for accessing information from outside the multimedia player. The tuner 120 is arranged to select one of a plurality of channels, and the video processing module 130 is arranged to perform video processing. For example, the tuner 120 can be a digital tuner and the video processing module 130 can be a digital processing module implemented with digital signal processing (DSP) technology. In another example, the tuner 120 can be an analog tuner and the video processing module 130 can be a signal processing module.

According to a special case of this embodiment, in a situation where the tuner 120 is a digital tuner, the video processing module 130 can be a video processing circuit comprising a Moving Picture Experts Group (MPEG) demultiplexer 132, an MPEG video decoder 134, and an image processor 136 (which are illustrated as an example of the architecture of the video processing module 130 shown in FIG. 1A, for better comprehension). The MPEG demultiplexer 132 is arranged to demultiplex video content and audio content of a program on the channel selected by the tuner 120 such as the digital tuner. In addition, the MPEG video decoder 134 is arranged to decode the video content demultiplexed by the MPEG demultiplexer 132, and more particularly, to perform MPEG-decoding on the video content. Additionally, the image processor 136 may further perform image processing on the decoded video content to be displayed. This is for illustrative purposes only, and is not meant to be a limitation of the present invention. In a situation where the tuner 120 is an analog tuner, the video processing module 130 may comprise some components arranged to perform signal processing, where implementing the MPEG demultiplexer 132, the MPEG video decoder 134, and the image processor 136 mentioned above within the video processing module 130 is not required. Please note that, no matter whether the tuner 120 is a digital tuner or an analog tuner, the video processing module 130 may further comprise an on screen display (OSD) module 138 arranged to perform OSD operations under control of the processing circuit 110, in order to mix OSD information into the video content to be displayed. In addition, according to different variations of this embodiment, a display module can be integrated into the apparatus 100.

According to the embodiment shown in FIG. 1A, the processing circuit 110 is arranged to perform broadcasting program schedule control. More particularly, the BPCP serving module 112 is arranged to receive at least one notification/command from outside the multimedia player through a BPCP, where the aforementioned at least one notification/command carries information corresponding to a multichannel broadcasting program to be viewed. For example, the notification/command can be carried by a wireless signal, which is typically sent from an electronic device outside the apparatus 100 through an antenna of the electronic device based upon a protocol such as the BPCP mentioned above. In addition, the service control module 114 is arranged to control operations of the multimedia player in response to the aforementioned at least one notification/command, in order to provide a user with a service corresponding to the multichannel broadcasting program. In practice, the communication device 140 can be a wireless communication device, and the apparatus 100 can utilize the communication device 140 to receive the notification/command carried by the wireless signal mentioned above.

Please note that the implementation of the apparatus 100 may vary according to different embodiments, such as the embodiment shown in FIG. 1A or some variations thereof. For example, the apparatus 100 may comprise at least one portion (e.g. a portion or all) of the multimedia player. In a situation where the apparatus 100 comprises a portion of the multimedia player, the processing circuit 110 can be the control circuit of the multimedia player, such as an integrated circuit (IC). In a situation where the apparatus 100 comprises the whole of the multimedia player, the apparatus 100 can be the multimedia player, or can be an audio/video reproducing system comprising the multimedia player.

In some embodiments, such as the embodiment shown in FIG. 1A or some variations thereof, the multimedia player mentioned above can be one of a digital video recorder (DVR) (which can be equipped with program receiving functionality, for example), an optical disc player, a set top box (STB), a television (TV), and a TV receiver, or can be a combination of a DVR, an optical disc player, an STB, a TV, and/or a TV receiver. According to one of these embodiments, such as that shown in FIG. 1B, the multimedia player can be a TV 100-1 comprising a screen 150 (e.g. a liquid crystal display (LCD) panel) for displaying images of a program, where the apparatus 100 may comprise at least one portion (e.g. a portion or all) of the TV 100-1. According to another of these embodiments, such as that shown in FIG. 1C, the multimedia player can be an STB 100-2, which is typically electronically connected to a monitor 100M, where the apparatus 100 may comprise at least one portion (e.g. a portion or all) of the STB 100-2. For example, the monitor 100M comprises the screen 150 (e.g. an LCD panel) arranged to display images of a program, and more particularly, the images carried by at least one signal sent from the STB 100-2.

FIG. 1D is a diagram of an apparatus 1000 for performing broadcasting program schedule control according to another embodiment of the present invention. The apparatus 1000 comprises a processing circuit 1110 arranged to control operations of an electronic device such as that mentioned above, and further perform broadcasting program schedule control, where the processing circuit 1110 comprises a data retrieving module 1112 and a schedule control module 1114. As shown in FIG. 1D, the apparatus 1000 may comprise a user interface module 1120 such as an LCD touch panel (e.g. an LCD panel having a transparent touch pad implemented thereon), and further comprise at least one communication device 1140 (labeled “Comm device” in FIG. 1D), while the communication device 1140 can be utilized for performing communication operations, and more particularly, for accessing information from outside the electronic device. For example, in a situation where the aforementioned at least one communication device 1140 comprises a communication device complying with a certain specification (e.g. a Bluetooth communication device, an infrared (IR) communication device, or a network communication device) and the aforementioned at least one communication device 140 also comprises a communication device complying with the same specification, the apparatus 1000 and the apparatus 100 can communicate with each other through the two communication devices complying with the same specification. In practice, regarding the communication between the apparatus 1000 and the apparatus 100, the aforementioned protocol such as the BPCP mentioned above may be involved with a data structure comprising a plurality of fields, which may comprise a first field for specifying the data source (e.g. the host such as the apparatus 100, or the client such as the apparatus 1000), a second field for identifying the client, and a third field for carrying data. If the content of the second field is omitted, the associated booking information is not associated to any client.

According to this embodiment, the data retrieving module 1112 is arranged to obtain electronic program guide (EPG) data from outside the electronic device through the communication device 1140, for use of broadcasting program schedule control, where the EPG data comprises broadcasting schedule information of a plurality of multichannel broadcasting programs. For example, the data retrieving module 1112 can obtain the EPG data from the apparatus 100. In addition, the schedule control module 1114 is arranged to parse the EPG data, and further provide the user with at least one hint through the electronic device, allowing the user to designate at least one multichannel broadcasting program to be viewed within the plurality of multichannel broadcasting programs. For example, the schedule control module 1114 can provide the user with the aforementioned at least one hint through the user interface module 1120 such as the LCD touch panel mentioned above. Based upon default settings or user settings, when it is the time for viewing the multichannel broadcasting program, the schedule control module 1114 can notify the user of viewing the multichannel broadcasting program (which means the schedule control module 1114 can notify the user of the fact that it is the time for viewing the multichannel broadcasting program) and/or send the aforementioned at least one notification/command to the apparatus 100.

In particular, the electronic device can be a portable electronic device used in a telecommunication network, such as a mobile phone or a multifunctional portable electronic device equipped with mobile phone functionalities. The apparatus 1000 may be equipped with a plurality of wireless communication capabilities. As a result, the apparatus 1000 (and more particularly, the processing circuit 1110 therein) can provide the user with a service of establishing a phone call connection (and more particularly, a connection over the telecommunication network between the calling party and the called party) by utilizing a wireless communication module such as at least one portion (e.g. a portion or all) of the aforementioned at least one communication device 1140. For example, the wireless communication module of this embodiment is capable of establishing a communication channel through an RF transceiver (not shown) of the wireless communication module. This is for illustrative purposes only, and is not meant to be a limitation of the present invention. According to some variations of this embodiment, the wireless communication module provides the apparatus 1000 with 2nd Generation (2G) wireless communication capability such as GSM communication capability, the so-called 2.5G wireless communication capability such as General Packet Radio Service (GPRS) communication capability, 3rd Generation (3G) wireless communication capability such as Wideband Code Division Multiple Access (WCDMA) communication capability, the so-called 3.5G wireless communication capability such as High-Speed Packet Access (HSPA) communication capability, and/or 4G wireless communication capability such as Worldwide Interoperability for Microwave Access (WIMAX) communication capability.

Please note that the implementation of the apparatus 1000 may vary according to different embodiments, such as the embodiment shown in FIG. 1D or some variations thereof. For example, the apparatus 1000 may comprise at least one portion (e.g. a portion or all) of the electronic device. In a situation where the apparatus 1000 comprises a portion of the electronic device, the processing circuit 1110 can be the control circuit of the electronic device, such as an IC therein. In a situation where the apparatus 1000 comprises the whole of the electronic device, the apparatus 1000 can be the electronic device, or can be a control system comprising the electronic device.

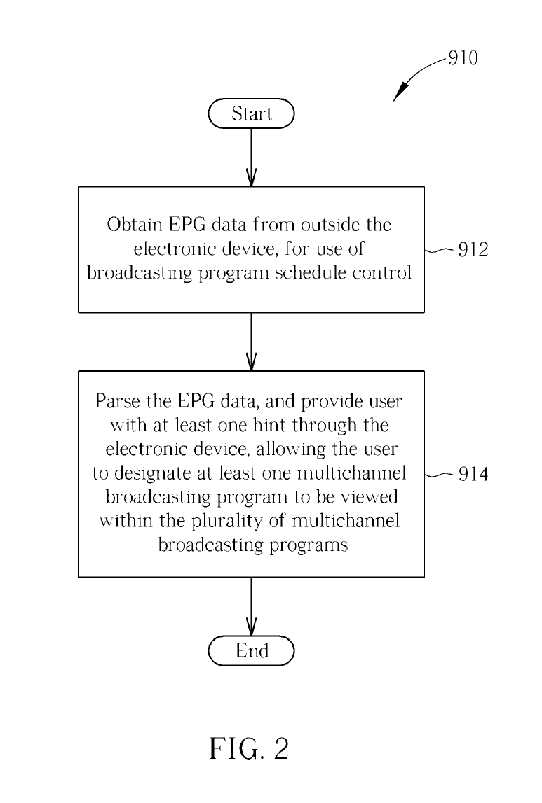

FIG. 2 is a flowchart of a method 910 for performing broadcasting program schedule control through an electronic device such as that mentioned above according to an embodiment of the present invention. The method 910 shown in FIG. 2 can be applied to the apparatus 1000, and more particularly, to the processing circuit 1110. In addition, the method 910 shown in FIG. 2 can be implemented by utilizing the apparatuses 100 and 1000, and more particularly, by utilizing the processing circuits 110 and 1110. The method is described as follows.

In Step 912, the data retrieving module 1112 obtains EPG data such as that mentioned above from outside the electronic device, and more particularly, from the apparatus 100, for use of broadcasting program schedule control, where the EPG data comprises broadcasting schedule information of a plurality of multichannel broadcasting programs such as those mentioned above. In this embodiment, the data retrieving module 1112 obtains the EPG data from the apparatus 100. This is for illustrative purposes only, and is not meant to be a limitation of the present invention. According to a variation of this embodiment, the data retrieving module 1112 can obtain the EPG data from a website through Internet. According to another variation of this embodiment, the data retrieving module 1112 can obtain the EPG data from a service provider.

In Step 914, the schedule control module 1114 parses the EPG data, and provides the user with at least one hint such as that mentioned above through the electronic device, allowing the user to designate at least one multichannel broadcasting program to be viewed (e.g. one or more multichannel broadcasting programs to be viewed) within the plurality of multichannel broadcasting programs. In this embodiment, the aforementioned at least one hint may guide the user to designate the aforementioned at least one multichannel broadcasting program to be viewed. As a result, the schedule control module 1114 generates/updates schedule information, where the schedule information represents a schedule for the user to view the aforementioned at least one multichannel broadcasting program.

According to this embodiment, when it is detected that the time for viewing the multichannel broadcasting program falls within a predetermined time period since the current time, the schedule control module 1114 remotely controls the multimedia player by utilizing a remote control module of the electronic device, in order to make the multimedia player provide the user with a service corresponding to the multichannel broadcasting program. For example, when it is detected that the time for viewing the multichannel broadcasting program falls within the predetermined time period since the current time, the schedule control module 1114 remotely controls the multimedia player to provide the user with a message indicating the multichannel broadcasting program to be viewed. This is for illustrative purposes only, and is not meant to be a limitation of the present invention. According to a variation of this embodiment, in a situation where changing a power on/off state of a portion of the apparatus 100 can be triggered by the schedule control module 1114, when it is detected that the time for viewing the multichannel broadcasting program falls within the predetermined time period since the current time, the schedule control module 1114 can remotely control the multimedia player to turn on a main power of the multimedia player, in order to make the multimedia player exit from a standby mode.

According to this variation, based upon the aforementioned at least one notification/command, when the time for viewing the multichannel broadcasting program falls within the predetermined time period since the current time, the service control module 114 triggers the main power of the multimedia player to be turned on. Thus, the main power of the multimedia player can automatically be turned on when needed. For example, in a situation where the aforementioned at least one notification/command indicates that turning on the main power of the multimedia player at once is required, the service control module 114 triggers the main power of the multimedia player to be turned on.

In addition, the aforementioned at least one notification/command may further indicate that switching/tuning to a channel corresponding to the multichannel broadcasting program to be viewed is required, and the service control module 114 may operate according to the aforementioned at least one notification/command. More particularly, when it is the time for viewing the multichannel broadcasting program, the schedule control module 1114 remotely controls the multimedia player to automatically switch/tune to the channel corresponding to the multichannel broadcasting program to be viewed.

According to a special case of the embodiment shown in FIG. 2, the predetermined time period may approach (or even reach) zero. Therefore, when it is the time for viewing the multichannel broadcasting program, the schedule control module 1114 remotely controls the multimedia player by utilizing the remote control module of the electronic device, in order to make the multimedia player provide the user with the service corresponding to the multichannel broadcasting program. For example, when it is the time for viewing the multichannel broadcasting program, the schedule control module 1114 remotely controls the multimedia player to provide the user with the aforementioned message indicating the multichannel broadcasting program to be viewed, and further remotely controls the multimedia player to automatically switch/tune to the channel corresponding to the multichannel broadcasting program to be viewed.

According to a special case of the above disclosed variation of the embodiment shown in FIG. 2, the predetermined time period may approach (or even reach) zero. Therefore, when it is the time for viewing the multichannel broadcasting program, the schedule control module 1114 can remotely control the multimedia player to turn on the main power of the multimedia player, in order to make the multimedia player exit from the standby mode. In addition, based upon the aforementioned at least one notification/command, when it is the time for viewing the multichannel broadcasting program, the service control module 114 triggers the main power of the multimedia player to be turned on.

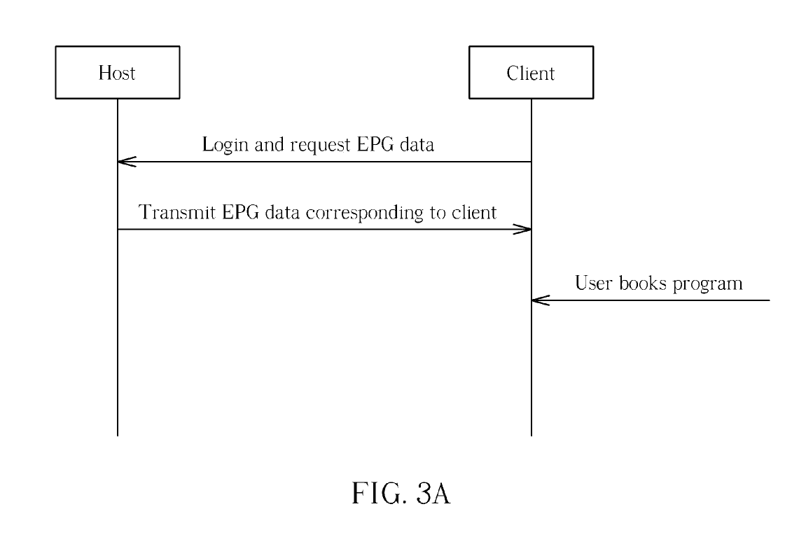

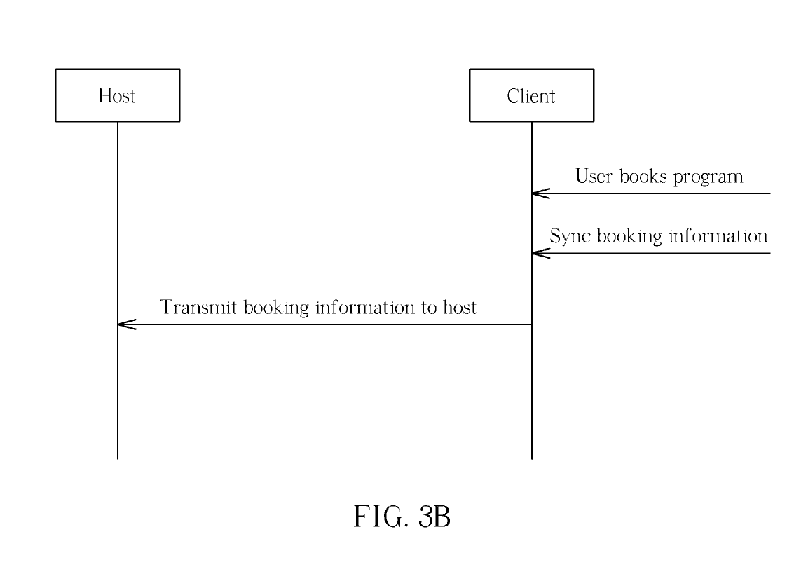

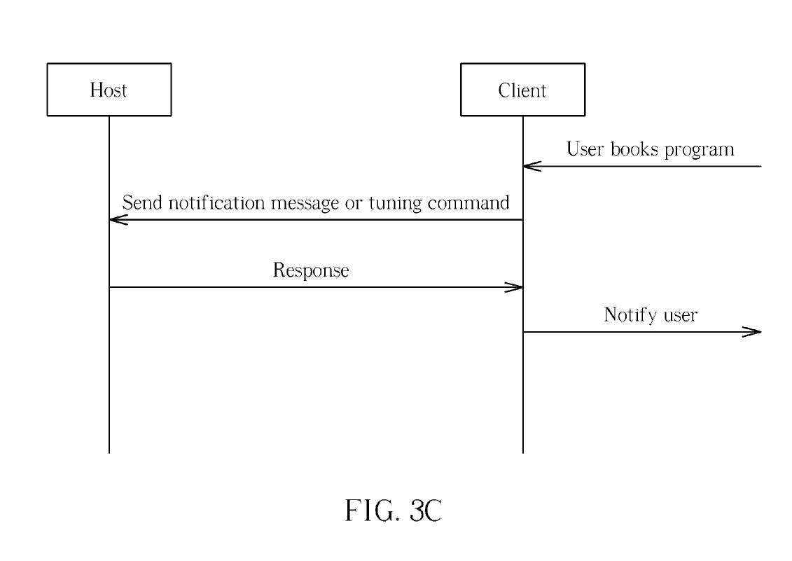

FIGS. 3A-3C illustrate some implementation details of the method 910 shown in FIG. 2 according to different embodiments of the present invention. In these embodiments, the host shown in FIGS. 3A-3C may represent the apparatus 100, and the client shown in FIGS. 3A-3C may represent the apparatus 1000.

In the embodiment shown in FIG. 3A, the data retrieving module 1112 of the apparatus 1000 can login and request the EPG data mentioned above, and more particularly, send an EPG request to the apparatus 100. Then, when receiving the EPG request from outside the multimedia player (more particularly, from the data retrieving module 1112), the BPCP serving module 112 sends the EPG data in response to the EPG request. For example, in a situation where there are multiple clients for the host, when receiving the EPG request from the client shown in FIG. 3A, the BPCP serving module 112 transmits the EPG data corresponding to the client. Thus, after the data retrieving module 1112 receives the EPG data, the schedule control module 1114 parses the EPG data and provides the user with the aforementioned at least one hint, allowing the user to designate the aforementioned at least one multichannel broadcasting program to be viewed. As a result, the user books the multichannel broadcasting program to be viewed (labeled “User books program” around the lower right of FIG. 3A).

In the embodiment shown in FIG. 3B, the apparatus 100 is capable of storing booking information of the aforementioned at least one multichannel broadcasting program to be viewed. In addition, the schedule control module 1114 provides the user with the aforementioned at least one hint, allowing the user to designate the aforementioned at least one multichannel broadcasting program to be viewed. As a result, the user books the multichannel broadcasting program to be viewed (labeled “User books program” around the upper right of FIG. 3B), where the schedule control module 1114 stores the booking information of the multichannel broadcasting program to be viewed into a storage within the apparatus 1000 (e.g. a non-volatile memory such as a Flash memory implemented within/outside the processing circuit 1110). Then, the user may activate (or trigger) a synchronization operation to synchronize the booking information of the multichannel broadcasting program to be viewed (labeled “Sync booking information” around the rightmost of FIG. 3B). Thus, the data retrieving module 1112 transmits the booking information to the host such as the apparatus 100. For example, the apparatus 100 of this embodiment may be equipped with a schedule control module (not shown), and according to the booking information, the schedule control module of the apparatus 100 can perform schedule control regarding the multichannel broadcasting program to be viewed.

In the embodiment shown in FIG. 3C, the schedule control module 1114 provides the user with the aforementioned at least one hint, allowing the user to designate the aforementioned at least one multichannel broadcasting program to be viewed. As a result, the user books the multichannel broadcasting program to be viewed (labeled “User books program” around the upper right of FIG. 3C), where the schedule control module 1114 stores the booking information of the multichannel broadcasting program to be viewed into a storage such as that mentioned above. According to this embodiment, the aforementioned at least one notification/command may comprise a notification message and/or a tuning command. When the time for viewing the multichannel broadcasting program falls within the predetermined time period since the current time, the schedule control module 1114 sends the aforementioned at least one notification/command (labeled “Send notification message or tuning command” in FIG. 3C, for example) through the data retrieving module 1112. Please note that the data retrieving module 1112 can be utilized for sending the aforementioned at least one notification/command through the aforementioned protocol such as the BPCP mentioned above, and therefore, can be regarded as a BPCP accessing module within the apparatus 1000. When receiving the aforementioned at least one notification/command from the apparatus 1000, the BPCP serving module 112 of the apparatus 100 is arranged to send a response to the apparatus 1000, and perform some operation(s) to provide the user with the aforementioned service corresponding to the multichannel broadcasting program to be viewed. For example, the schedule control module 1114 can notify the user of viewing the multichannel broadcasting program after receiving the response from the apparatus 100. This is for illustrative purposes only, and is not meant to be a limitation of the present invention. According to a variation of this embodiment, the schedule control module 1114 can notify the user of viewing the multichannel broadcasting program no matter whether any response is received from the apparatus 100 or not.

According to some variations of this embodiment, the operation of notifying the user of viewing the multichannel broadcasting program can be performed before/after the operation of sending the aforementioned at least one notification/command is performed. According to some variations of this embodiment, the schedule control module 1114 can send the aforementioned at least one notification/command and notify the user of viewing the multichannel broadcasting program at the same time.

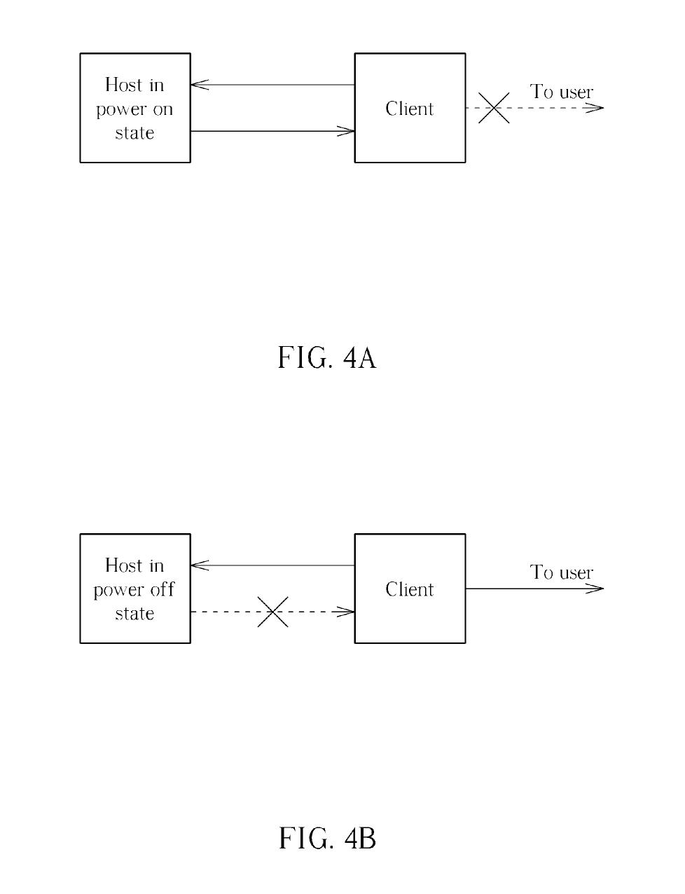

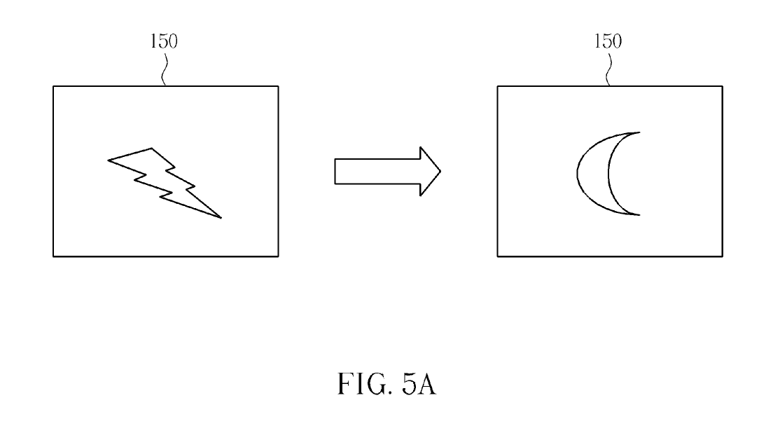

FIGS. 4A-4B illustrate some implementation details of the method 910 shown in FIG. 2 according to different embodiments of the present invention. In these embodiments, the host shown in FIGS. 4A-4B (labeled “Host in power on state” and “Host in power off state” in FIGS. 4A-4B, respectively) may represent the apparatus 100, and the client shown in FIGS. 4A-4B may represent the apparatus 1000.

According to the embodiment shown in FIG. 4A, in a situation where the apparatus 100 is in a power on state, when the apparatus 1000 sends the aforementioned at least one notification/command to the apparatus 100, the apparatus 100 may send a response to the apparatus 1000. In this embodiment, as the apparatus 1000 receives the response from the apparatus 100, the service control module 114 will control operations of the multimedia player in response to the aforementioned at least one notification/command in order to provide the user with the service corresponding to the multichannel broadcasting program. Thus, the apparatus 1000 has no need to notify the user of viewing the multichannel broadcasting program, where the dashed line shown in FIG. 4A illustrates this situation. This is for illustrative purposes only, and is not meant to be a limitation of the present invention. According to a variation of this embodiment, in a situation where the apparatus 1000 receives the response from the apparatus 100, the apparatus 100 may still notify the user of viewing the multichannel broadcasting program.

According to the embodiment shown in FIG. 4B, in a situation where the apparatus 100 is in a power off state, when the apparatus 1000 sends the aforementioned at least one notification/command to the apparatus 100, the apparatus 100 of this embodiment keeps staying in the power off state and does not send a response to the apparatus 1000. In this embodiment, the apparatus 1000 does not receive any response from the apparatus 100. For the apparatus 1000 of this embodiment, it cannot be guaranteed that the service control module 114 will control operations of the multimedia player in response to the aforementioned at least one notification/command. Thus, when it is detected that the time for viewing the multichannel broadcasting program falls within the predetermined time period since the current time, the schedule control module 1114 provides the user with a hint through the electronic device, such as a message displayed on the LCD touch panel, a sound output from a speaker of the electronic device, or vibration generated by a vibration module in the electronic device, in order to notify the user of viewing the multichannel broadcasting program. According to a special case of this embodiment, the predetermined time period may approach (or even reach) zero. Therefore, when it is the time for viewing the multichannel broadcasting program, the schedule control module 1114 provides the user with the hint through the electronic device, in order to notify the user of viewing the multichannel broadcasting program.

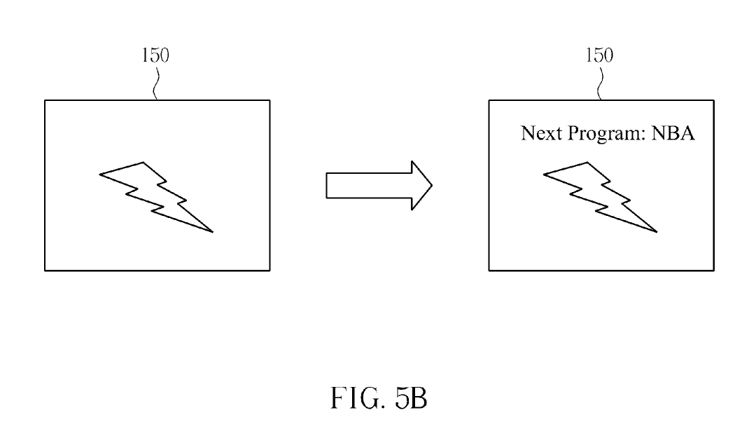

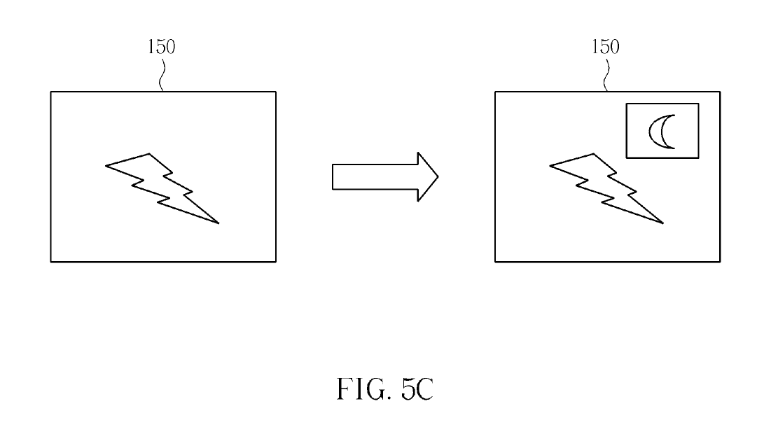

FIGS. 5A-5C illustrate some implementation details of the method 910 shown in FIG. 2 according to different embodiments of the present invention. Please note that the operations disclosed in these embodiments are performed in response to the aforementioned at least one notification/command.

In the embodiment shown in FIG. 5A, based upon the aforementioned at least one notification/command, when it is the time for viewing the multichannel broadcasting program, the service control module 114 controls the multimedia player to automatically switch/tune to the channel corresponding to the multichannel broadcasting program to be viewed. For example, in a situation where the aforementioned at least one notification/command indicates that it is the time for viewing the multichannel broadcasting program now, the service control module 114 controls the multimedia player to automatically switch/tune to the channel corresponding to the multichannel broadcasting program to be viewed. As a result, an image of an original multichannel broadcasting program (e.g. the image displayed in the screen 150 shown in the left half of FIG. 5A) is replaced by an image of the multichannel broadcasting program to be viewed (e.g. the image displayed in the screen 150 shown in the right half of FIG. 5A).

In the embodiment shown in FIG. 5B, based upon the aforementioned at least one notification/command, when the time for viewing the multichannel broadcasting program falls within the predetermined time period since the current time, the service control module 114 provides the user with the aforementioned message indicating the multichannel broadcasting program to be viewed, such as the message “Next Program: NBA” shown in the right half of FIG. 5B. For example, in a situation where the aforementioned at least one notification/command indicates that the time for viewing the multichannel broadcasting program is a few minutes (e.g. three minutes) later, the service control module 114 provides the user with the message through OSD operations, in order to notify the user of such a situation. At this moment, the service control module 114 does not control the multimedia player to automatically switch/tune to the channel corresponding to the multichannel broadcasting program to be viewed, and therefore, when the message “Next Program: NBA” shown in the right half of FIG. 5B is displayed on the screen 150, the image of the original multichannel broadcasting program (e.g. the image displayed in the screen 150 shown in the left half of FIG. 5B) is not replaced by any image of the multichannel broadcasting program to be viewed. This is for illustrative purposes only, and is not meant to be a limitation of the present invention. According to a variation of this embodiment, the service control module 114 can control the multimedia player to automatically switch/tune to the new channel (i.e. the channel corresponding to the multichannel broadcasting program to be viewed) in advance, even in a situation where the aforementioned at least one notification/command does not indicate the apparatus 1000 to do so at this moment. According to another variation of this embodiment, based upon the aforementioned at least one notification/command, the service control module 114 controls the multimedia player to automatically switch/tune to the new channel in advance since the aforementioned at least one notification/command of this variation indicates the apparatus 1000 to do so at this moment (i.e. the moment when the message “Next Program: NBA” shown in the right half of FIG. 5B is displayed on the screen 150).

In the embodiment shown in FIG. 5C, based upon the aforementioned at least one notification/command, when it is the time for viewing the multichannel broadcasting program, the service control module 114 controls the multimedia player to play the original multichannel broadcasting program and the multichannel broadcasting program to be viewed at the same time, where the original multichannel broadcasting program and the multichannel broadcasting program to be viewed are broadcasted on different channels, respectively. As a result, the image of the original multichannel broadcasting program (e.g. the image displayed in the screen 150 shown in the left half of FIG. 5C) is replaced by a combination of at least one portion (e.g. a portion or all) of the image of the multichannel broadcasting program to be viewed and at least one portion (e.g. a portion or all) of the image of the original multichannel broadcasting program, such as the combined image displayed in the screen 150 shown in the right half of FIG. 5C. According to this embodiment, the mode for displaying the combined image shown in the right half of FIG. 5C can be regarded as a picture in picture (pip) mode.

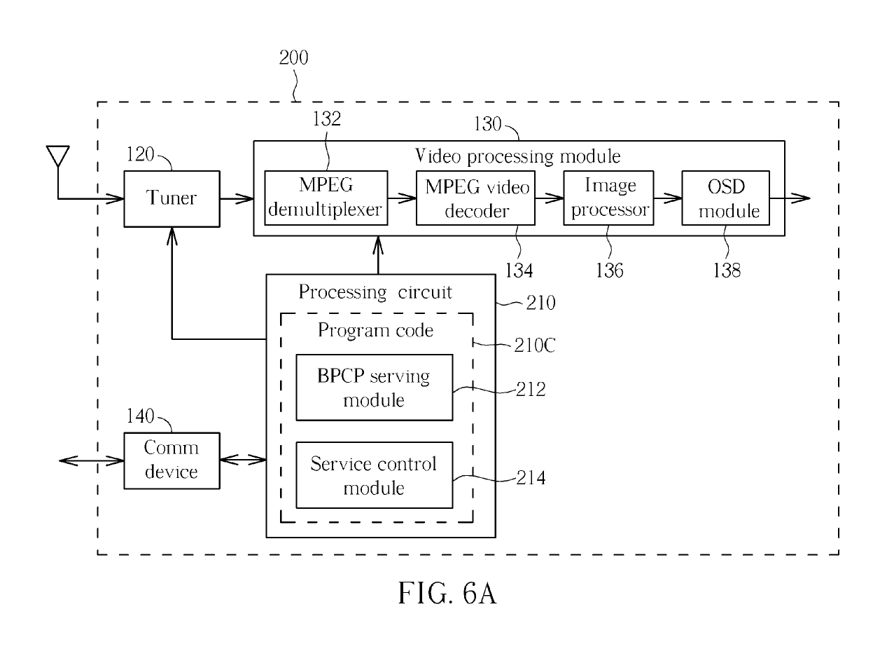

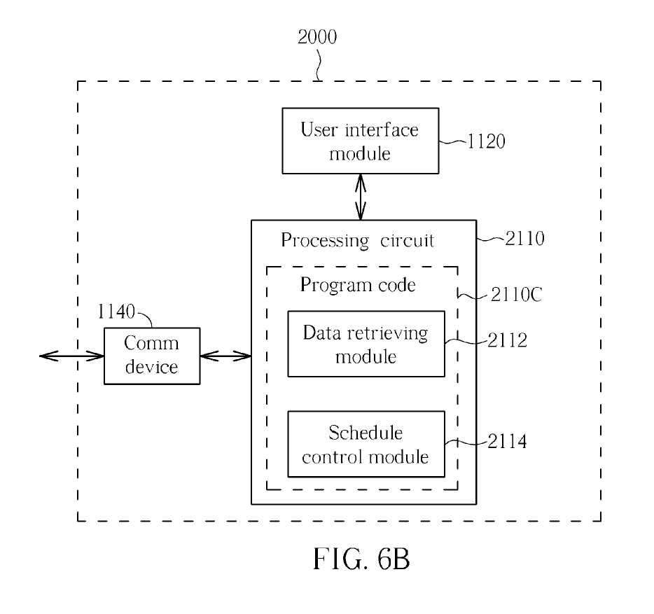

FIG. 6A is a diagram of an apparatus 200 for performing broadcasting program schedule control according to a second embodiment of the present invention. According to this embodiment, the processing circuit mentioned in the embodiment shown in FIG. 1A can be implemented by utilizing a processing circuit executing a program code 210C, and therefore, can be labeled with another numeral 210 in response to the change in architecture, where the apparatus mentioned in the embodiment shown in FIG. 1A can be labeled with the numeral 200 in response to the change in architecture. In addition, the program code 210C may comprise at least one program module, such as a BPCP serving module 212 and a service control module 214, where the processing circuit 210 executing the BPCP serving module 212 can perform operations that are the same as or similar to those of the BPCP serving module 112, and the processing circuit 210 executing the service control module 214 can perform operations that are the same as or similar to those of the service control module 114. Similar descriptions are not repeated for this embodiment.

FIG. 6B is a diagram of an apparatus 2000 for performing broadcasting program schedule control according to another embodiment of the present invention. According to this embodiment, the processing circuit mentioned in the embodiment shown in FIG. 1D can be implemented by utilizing a processing circuit executing a program code 2110C, and therefore, can be labeled with another numeral 2110 in response to the change in architecture, where the apparatus mentioned in the embodiment shown in FIG. 1D can be labeled with the numeral 2000 in response to the change in architecture. In addition, the program code 2110C may comprise at least one program module, such as a data retrieving module 2112 and a schedule control module 2114, where the processing circuit 2110 executing the data retrieving module 2112 can perform operations that are the same as or similar to those of the data retrieving module 1112, and the processing circuit 2110 executing the schedule control module 2114 can perform operations that are the same as or similar to those of the schedule control module 1114. Similar descriptions are not repeated for this embodiment.

It is an advantage of the present invention that the present invention methods and apparatuses can server the user well. In addition, with the aid of the electronic device such as the portable electronic device, the multimedia player can automatically turn on or switch/tune to the channel corresponding to the multichannel broadcasting program to be viewed, and therefore, the user can view the multichannel broadcasting program in time, having no need to go finding any EPG or the like. Additionally, in a situation where the user is travelling around the country, the electronic device such as the portable electronic device can notify the user of viewing the multichannel broadcasting program on schedule.

Those skilled in the art will readily observe that numerous modifications and alterations of the device and method may be made while retaining the teachings of the invention.

1. A method for performing broadcasting program schedule control through an electronic device, the method comprising:
obtaining electronic program guide (EPG) data from outside the electronic device, for use of broadcasting program schedule control, wherein the EPG data comprises broadcasting schedule information of a plurality of multichannel broadcasting programs;
parsing the EPG data, and further providing a user with at least one hint through the electronic device, allowing the user to designate at least one multichannel broadcasting program to be viewed within the plurality of multichannel broadcasting programs; and
remotely controlling a multimedia player in order to make the multimedia player provide the user with a service corresponding to the multichannel broadcasting program;
wherein the electronic device is a portable electronic device used in a telecommunication network.

2. The method of claim 1, further comprising:
when it is detected that a time for viewing the multichannel broadcasting program falls within a predetermined time period since a current time, providing the user with the hint through the electronic device, in order to notify the user of viewing the multichannel broadcasting program.

3. The method of claim 1, further comprising:
when it is detected that a time for viewing the multichannel broadcasting program falls within a predetermined time period since a current time, remotely controlling the multimedia player by utilizing a remote control module of the electronic device.

4. The method of claim 3, wherein the step of remotely controlling the multimedia player by utilizing the remote control module of the electronic device in order to make the multimedia player provide the user with the service corresponding to the multichannel broadcasting program further comprises:
when it is detected that the time for viewing the multichannel broadcasting program falls within the predetermined time period since the current time, remotely controlling the multimedia player to turn on a main power of the multimedia player.

5. The method of claim 3, wherein the step of remotely controlling the multimedia player by utilizing the remote control module of the electronic device in order to make the multimedia player provide the user with the service corresponding to the multichannel broadcasting program further comprises:
when it is detected that the time for viewing the multichannel broadcasting program falls within the predetermined time period since the current time, remotely controlling the multimedia player to provide the user with a message indicating the multichannel broadcasting program to be viewed.

6. The method of claim 1, further comprising:
when it is a time for viewing the multichannel broadcasting program, remotely controlling the multimedia player to automatically switch/tune to a channel corresponding to the multichannel broadcasting program to be viewed.

7. The method of claim 1, further comprising:
when it is a time for viewing the multichannel broadcasting program, remotely controlling the multimedia player to play an original multichannel broadcasting program and the multichannel broadcasting program to be viewed at a same time, where the original multichannel broadcasting program and the multichannel broadcasting program to be viewed are broadcasted on different channels, respectively.

8. An apparatus for performing broadcasting program schedule control, the apparatus comprising at least one portion of an electronic device, the apparatus comprising:
a processing circuit arranged to perform broadcasting program schedule control, wherein the processing circuit comprises:
a data retrieving module arranged to obtain electronic program guide (EPG) data from outside the electronic device, for use of broadcasting program schedule control, wherein the EPG data comprises broadcasting schedule information of a plurality of multichannel broadcasting programs; and
a schedule control module arranged to parse the EPG data, and further provide a user with at least one hint through the electronic device, allowing the user to designate at least one multichannel broadcasting program to be viewed within the plurality of multichannel broadcasting programs, and remotely control a multimedia player in order to make the multimedia player provide the user with a service corresponding to the multichannel broadcasting program;
wherein the electronic device is a portable electronic device used in a telecommunication network.

9. The apparatus of claim 8, wherein when it is detected that a time for viewing the multichannel broadcasting program falls within a predetermined time period since a current time, the schedule control module provides the user with the hint through the electronic device, in order to notify the user of viewing the multichannel broadcasting program.

10. The apparatus of claim 8, wherein when it is detected that a time for viewing the multichannel broadcasting program falls within a predetermined time period since a current time, the schedule control module remotely controls the multimedia player by utilizing a remote control module of the electronic device.

11. The apparatus of claim 10, wherein when it is detected that the time for viewing the multichannel broadcasting program falls within the predetermined time period since the current time, the schedule control module remotely controls the multimedia player to turn on a main power of the multimedia player.

12. The apparatus of claim 10, wherein when it is detected that the time for viewing the multichannel broadcasting program falls within the predetermined time period since the current time, the schedule control module remotely controls the multimedia player to provide the user with a message indicating the multichannel broadcasting program to be viewed.

13. The apparatus of claim 8, wherein when it is a time for viewing the multichannel broadcasting program, the schedule control module remotely controls the multimedia player to automatically switch/tune to a channel corresponding to the multichannel broadcasting program to be viewed.

14. The apparatus of claim 8, wherein when it is a time for viewing the multichannel broadcasting program, the schedule control module remotely controls the multimedia player to play an original multichannel broadcasting program and the multichannel broadcasting program to be viewed at a same time; and the original multichannel broadcasting program and the multichannel broadcasting program to be viewed are broadcasted on different channels, respectively.

15. An apparatus for performing broadcasting program schedule control, the apparatus comprising at least one portion of a multimedia player, the apparatus comprising:
a processing circuit arranged to perform broadcasting program schedule control, wherein the processing circuit comprises:
a broadcasting program control protocol (BPCP) serving module arranged to receive at least one notification/command from an electronic device outside the multimedia player through a BPCP, wherein the at least one notification/command carries information corresponding to a multichannel broadcasting program to be viewed;
a service control module arranged control operations of the multimedia player in response to the at least one notification/command, in order to provide a user with a service corresponding to the multichannel broadcasting program;
wherein the electronic device is a portable electronic device used in a telecommunication network.

16. The apparatus of claim 15, wherein when a time for viewing the multichannel broadcasting program falls within a predetermined time period since a current time, the service control module triggers a main power of the multimedia player to be turned on.

17. The apparatus of claim 15, wherein when a time for viewing the multichannel broadcasting program falls within a predetermined time period since a current time, the service control module provides the user with a message indicating the multichannel broadcasting program to be viewed.

18. The apparatus of claim 15, wherein when it is a time for viewing the multichannel broadcasting program, the service control module controls the multimedia player to automatically switch/tune to a channel corresponding to the multichannel broadcasting program to be viewed.

19. The apparatus of claim 15, wherein when it is a time for viewing the multichannel broadcasting program, the service control module controls the multimedia player to play an original multichannel broadcasting program and the multichannel broadcasting program to be viewed at a same time; and the original multichannel broadcasting program and the multichannel broadcasting program to be viewed are broadcasted on different channels, respectively.

20. The apparatus of claim 15, wherein when receiving an electronic program guide (EPG) request from the electronic device outside the multimedia player, the BPCP serving module sends EPG data in response to the EPG request.

21. The method of claim 1, wherein the electronic device is a mobile phone.

22. The method of claim 1, wherein the step of remotely controlling a multimedia player in order to make the multimedia player provide the user with a service corresponding to the multichannel broadcasting program further comprises:
communicating with the multimedia player by using at least one notification/command.

23. The apparatus of claim 8, wherein the electronic device is a mobile phone.
